(19) United States
(12) Patent Application Publication
(10) Pub. No.: US 2022/0091346 A1
(43) Pub. Date: Mar. 24, 2022

(54) OPTICAL CONNECTOR, OPTICAL CABLE, AND ELECTRONIC APPARATUS

(71) Applicant: SONY GROUP CORPORATION, TOKYO (JP)

(72) Inventors: HIROSHI MORITA, TOKYO (JP); KAZUAKI TOBA, KANAGAWA (JP); MASANARI YAMAMOTO, TOKYO (JP); YUSUKE OYAMA, TOKYO (JP)

(21) Appl. No.: 17/310,109

(22) PCT Filed: Jan. 16, 2020
(86) PCT No.: PCT/JP2020/001397

§ 371 Date: Jul. 16, 2021

(30) Foreign Application Priority Data
Jan. 25, 2019 (JP) 2019-010718

(51) Int. Cl. G02B 6/38; G02B 6/42

(52) U.S. Cl. CPC G02B 6/3853; G02B 6/4292; G02B 6/4206

(57) ABSTRACT

To satisfactorily prevent a laser hazard caused in a non-fitting state using a simple structure. A connector body is included that includes a lens and a diffusion section, the lens performing formation with respect to light that exits a light emitter, and causing light obtained by the formation to exit the lens, the diffusion section causing the light obtained by the formation performed by the lens to diffusely exit the diffusion section. For example, the diffusion section includes a microlens array or a diffusion plate. For example, a position regulator that regulates a fitting position at which the connector body fits a facing connector, is further included.

### TECHNICAL FIELD

The present technology relates to an optical connector, an optical cable, and an electronic apparatus. In particular, the present technology relates to, for example, an optical connector that makes it possible to avoid the risk due to light leakage in a non-fitting state.

### BACKGROUND ART

An optical connector using an optical coupling system, that is, a so-called optical coupling connector has been proposed in the past. The optical coupling connector makes it possible to provide a non-contact optical coupling by using collimated light coupling, which is different from, for example, a physical contact (PC) connector that is brought into physical contact. Thus, the optical coupling connector makes it possible to greatly relax the accuracy in optical-axis alignment. Further, the use of collimated light coupling makes it possible to secure an amount of light in spite of dust and dirt entering to be situated on an optical axis, which is different from a PC connector. Thus, the use of collimated light coupling makes it possible to easily ensure the communication quality.

However, it is difficult to attenuate output light power even at a location away from an exit portion since collimated light is parallel light. Depending on its intensity, it is difficult to satisfy safety standards related to laser light, such as IEC 60825-1 and IEC 60825-2.

For example, Patent Literature 1 proposes an optical connector intended to prevent a laser hazard, the optical connector including a lens portion and a fiber fixation portion that are separated from each other. Those components are in close contact with each other in a fitting state, and collimated light is output only in a fitting state.

### CITATION LIST

### Patent Literature

Patent Literature 1: Japanese Patent Application Laid-open No. 2013-64803

### DISCLOSURE OF INVENTION

### Technical Problem

In the optical connector disclosed in Patent Literature 1, the lens portion and the fiber fixation portion are brought into physical contact with each other in a fitting state. Thus, there is a possibility that the two components will not be properly brought into contact with each other when dust or dirt produced due to rubbing of a movable portion enters a space between the two components. This may result in a significant reduction in communication quality. Thus, there is a need to remove dust and dirt, but it is difficult to easily remove dust and dirt in terms of structure.

It is an object of the present technology to satisfactorily prevent a laser hazard caused in a non-fitting state using a simple structure.

### Solution to Problem

A concept of the present technology provides an optical connector that includes a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

In the present technology, a connector body is included that includes a lens and a diffusion section. The lens performs formation with respect to light that exits a light emitter, and causes light obtained by the formation to exit the lens. For example, the lens may form the light exiting the light emitter into collimated light. The diffusion section causes the light obtained by the formation performed by the lens to diffusely exit the diffusion section.

For example, the diffusion section may include a microlens array. In this case, when a connector that faces the optical connector uses a microlens array to have a configuration similar to the configuration of the optical connector, this enables communication performed using collimated light. Further, in this case, for example, the microlens array may be arranged such that a convex surface of each microlens faces the lens. In this case, an end surface of the connector body is flat. This makes it possible to easily perform cleaning when, for example, dust is attached. Furthermore, for example, the diffusion section may include a diffusion plate (a prism sheet or a microprism array). The diffusion plate can be produced more easily than a microlens array.

As described above, in the present technology, light exits the light emitter, and formation is performed by the lens with respect to the light. Light obtained by the formation enters the diffusion section, and diffusely exits the diffusion section. Thus, light that exits in a non-fitting state is diffused. This results in preventing a laser hazard caused in a non-fitting state using a simple structure.

Note that, in the present technology, for example, the connector body may include a first optical section that includes the lens, and a second optical section that includes the diffusion section. Such a configuration of the connector body including the first optical section and the second optical section provides the advantage of being able to easily perform production.

Further, in the present technology, for example, a holding section that holds the connector body in a floating state in a connector external housing, may be further included. In this case, it is possible to easily correct for the position of the connector body in a fitting state. Consequently, without accurately performing alignment on the basis of the connector housing, the connector body can be accurately aligned with the facing connector to fit the facing connector.

Furthermore, in the present technology, a position regulator that regulates a fitting position at which the connector body fits the facing connector, may be further included. This makes it possible to accurately regulate the position of the connector body with respect to the facing connector.

Moreover, in the present technology, for example, the light emitter may be an optical fiber, and the connector body may include an insertion hole into which the optical fiber is inserted. When the connector body includes the insertion hole into which the optical fiber serving as the light emitter is inserted, as described above, this makes it possible to easily fix the optical fiber to the connector body.

Further, in the present technology, for example, the light emitter may be a light-emitting element that converts an electric signal into an optical signal. When the light emitter is the light-emitting element, described above, this results in there being no need for an optical fiber upon transmitting an optical signal coming from the light-emitting element. This makes it possible to reduce costs.

In this case, for example, the light emitter may be connected to the connector body, and the light exiting the light emitter may enter the lens with no change in a path of the light. Moreover, for example, the connector body may include a light path changing section used to change a light path, and a path of the light exiting the light emitter may be changed by the light path changing section to cause the light to enter the lens. Accordingly, for example, a path of light coming from the light-emitting element fixed to a substrate can be changed by the light path changing section to cause the light to enter the lens. This results in easily implementing the light-emitting element, and thus in being able to increase a degree of freedom in design.

Furthermore, in the present technology, for example, the connector body may be made of a light-transmissive material, and may integrally include the lens. In this case, the accuracy in positioning the lens with respect to connector body can be improved.

Moreover, in the present technology, the connector body may include a plurality of the lenses. Such a configuration of the connector body including a plurality of the lenses makes it possible to easily perform a multichannel communication.

Further, in the present technology, for example, the light emitter may be further included. Such a configuration of including the light emitter makes it possible to omit mounting of the light emitter.

Further, another concept of the present technology provides an optical cable that includes an optical connector that serves as a plug, the optical connector including a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

Further, another concept of the present technology provides an electronic apparatus that includes an optical connector that serves as a receptacle, the optical connector including a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

### BRIEF DESCRIPTION OF DRAWINGS

FIG. 1 illustrates a general description of an optical communication performed by spatial coupling.

FIG. 2 illustrates a general description of an optical coupling connector to which the present technology is applied.

FIG. 3 is a diagram for describing how microlens arrays operate in a fitting state and in a non-fitting state.

FIG. 4 is a diagram for describing position regulators used to regulate a fitting position at which a microlens array on the transmission side and a microlens array on the reception side fit each other.

FIG. 5 is a diagram for describing the fitting position at which the microlens array on the transmission side and the microlens array on the reception side fit each other.

FIG. 6 illustrates an example in which there is a plurality of recesses into which a protrusion is to be inserted.

FIG. 7 illustrates an example of providing, at an entrance of a recess, a tapered portion that serves as a guide.

FIG. 8 illustrates an example of an arrangement of the microlens array on the transmission side.

FIG. 9 illustrates examples of configurations of an electronic apparatus and optical cables according to embodiments.

FIG. 10 is a perspective view illustrating examples of a transmission-side optical connector and a reception-side optical connector that are included in an optical coupling connector.

FIG. 11 is a perspective view illustrating the examples of the transmission-side optical connector and the reception-side optical connector that are included in the optical coupling connector.

FIG. 12 is a perspective view illustrating a state in which a first optical section and a second optical section of a connector body that is included in the transmission-side optical connector are separated from each other.

FIG. 13 is a set of cross-sectional views respectively illustrating the example of the transmission-side optical connector and the example of the reception-side optical connector.

FIG. 14 is a diagram for describing a fitting (connected) state and a non-fitting (unconnected) state of the transmission-side optical connector.

FIG. 15 is a cross-sectional view illustrating a transmission-side optical connector of another configuration example 1.

FIG. 16 is a cross-sectional view illustrating a transmission-side optical connector of another configuration example 2.

FIG. 17 is a cross-sectional view illustrating a transmission-side optical connector of another configuration example 3.

FIG. 18 is a cross-sectional view illustrating a transmission-side optical connector of another configuration example 4.

FIG. 19 is a set of cross-sectional views illustrating a transmission-side optical connector and a reception-side optical connector of another configuration example 5.

FIG. 20 is a set of a side view and a top view each illustrating a transmission-side optical connector of another configuration example 6.

FIG. 21 illustrates the transmission-side optical connector 300T-6 and a reception-side optical connector 300R-6 of the other configuration example 6 in a fitting (connected) state.

FIG. 22 is a set of cross-sectional views respectively illustrating a transmission-side optical connector and a reception-side optical connector of another configuration example 7.

FIG. 23 is a diagram for describing how diffusion plates operate in a fitting state and in a non-fitting state.

FIG. 24 is a diagram for describing a fitting (connected) state and a non-fitting (unconnected) state of the transmission-side optical connector.

### MODE(S) FOR CARRYING OUT THE INVENTION

Embodiments for carrying out the present technology (hereinafter referred to as “embodiments”) will now be described below. Note that the description is made in the following order.

### 1. Embodiments

### 2. Modifications

### 1. Embodiments

[Basic Description of Present Technology]

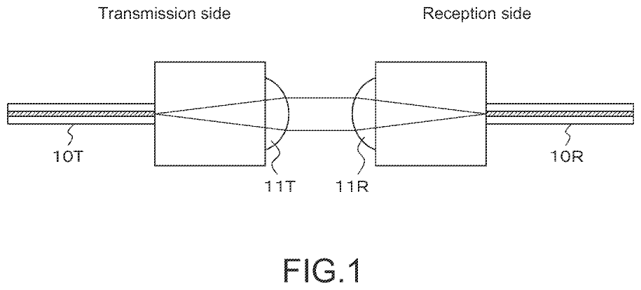

First, a technology related to the present technology is described. FIG. 1 illustrates a general description of an optical communication performed by spatial coupling. In this case, light exiting an optical fiber 10T on the transmission side is formed into collimated light by a lens 11T on the transmission side, and the collimated light exits the lens 11T. Then, the collimated light is collected by a lens 11R on the reception side, and enters an optical fiber 10R on the reception side.

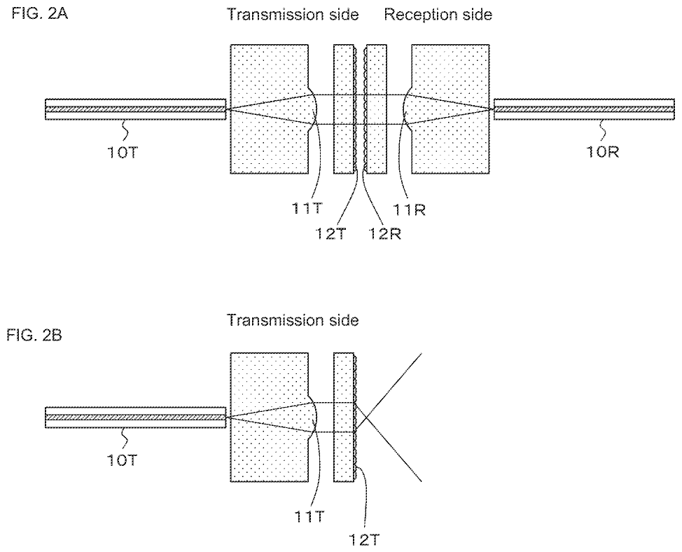

(a) of FIG. 2 illustrates a general description of an optical coupling connector to which the present technology is applied. The figure illustrates an optical connector on the transmission side and an optical connector on the reception side being in a fitting state (being connected to each other). The optical connector on the transmission side includes the lens 11T forming light exiting the optical fiber 10T into collimated light, and a microlens array 12T that causes the collimated light formed by the lens 11T to diffusely exit the microlens array 12T.

Further, the optical connector on the reception side includes a microlens array 12R that re-forms, into collimated light, the light diffusely exiting the microlens array 12T of the optical connector on the transmission side, and the lens 11R collecting the collimated light obtained by the re-formation performed by the microlens array 12R, and causes the collected light to enter the optical fiber 10R. Note that, as is well known, the microlens arrays 12T and 12R are each obtained by regularly integrating a number of very small convex lenses (microlenses).

When the optical connector on the transmission side and the optical connector on the reception side are in a fitting state, optical coupling is performed as indicated below. That is, light exiting the optical fiber 10T on the transmission side enters the lens 11T to be formed into collimated light by the lens 11T, and the collimated light exits the lens 11T. The collimated light exiting the lens 11T enters the microlens arrays 12T to diffusely exit the microlens arrays 12T.

Further, the light exiting the microlens array 12T enters the microlens array 12R on the reception side to be re-formed into collimated light by the microlens array 12R, and the collimated light exits the microlens array 12R. The light exiting the microlens array 12R is collected by the lens 11R to enter the optical fiber 10R.

When the optical connector on the transmission side and the optical connector on the reception side are in a fitting state, as described above, light exiting the optical fiber 10T on the transmission side enters the optical fiber 10R on the reception side. This makes it possible to perform an optical communication.

(b) of FIG. 2 illustrates the optical connector on the transmission side in a non-fitting (unconnected) position. In this case, light exiting the lens 11T enters the microlens array 12T to diffusely exit the microlens array 12T. In other words, light exiting the optical connector on the transmission side is diffused light. This results in satisfactorily preventing a laser hazard caused in a non-fitting state using a simple structure.

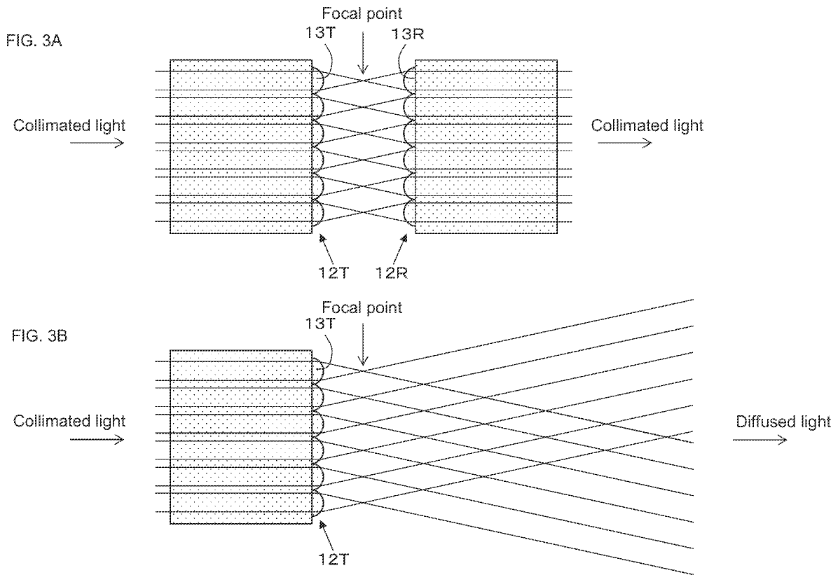

(a) of FIG. 3 illustrates how the microlens arrays 12T and 12R operate in a fitting state. A lens 13T that is included in the microlens array 12T on the transmission side refracts incident collimated light and causes the light to exit the lens 13T, such that the light passes through the focal point. Further, a lens 13R that is included in the microlens array 12R on the reception side refracts the incident light passing through the focal point and causes the light to exit the lens 13R, such that the light is formed into collimated light.

(b) of FIG. 3 illustrates how the microlens array 12T on the transmission side operates in a non-fitting state. The lens 13T included in the microlens array 12T refracts incident collimated light and causes the light to exit the lens 13T, such that the light passes through the focal point. Thus, the light exiting the microlens array 12T is diffused light.

Here, in order to cause the microlens arrays 12T and 12R to operate as illustrated in (a) of FIG. 3, it is necessary that a distance between the lenses 13T and 13R facing each other exhibit a constant value such that their focal points coincide each other, as illustrated in the figure. Further, there is a need to align optical axes of the facing lenses 13T and 13R. If the distance between the facing lenses 13T and 13R does not exhibit a constant value, light transmitted through the lens 13R will be diffused or converged without being formed into collimated light. Further, if the optical axes of the facing lenses 13T and 13R are not aligned, light that has passed through the lens 13R will be diffused without remaining collimated.

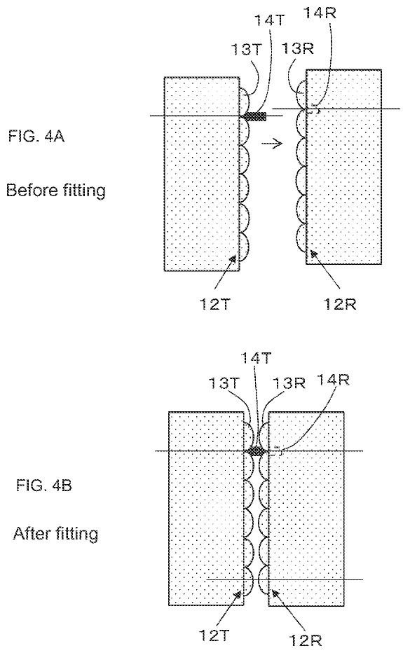

In the present technology, position regulators used to regulate a fitting position at which the microlens arrays 12T and 12R fit each other are provided so that a distance between the facing lenses 13T and 13R exhibits a constant value, and so that optical axes of the facing lenses 13T and 13R are aligned. For example, a cylindrical protrusion 14T of a specified length is provided on the side of the microlens array 12T, and a concave recess 14R into which the protrusion 14T is fitted is formed on the side of the microlens array 12R, as illustrated in, for example, FIG. 4.

(a) of FIG. 4 illustrates a state before the optical connector on the transmission side and the optical connector on the reception side fit each other, and (b) of FIG. 4 illustrates a state after the optical connector on the transmission side and the optical connector on the reception side fit each other. After the fitting, an end of the protrusion 14T on the side of the microlens array 12T is inserted into the recess 14R on the side of the microlens array 12R.

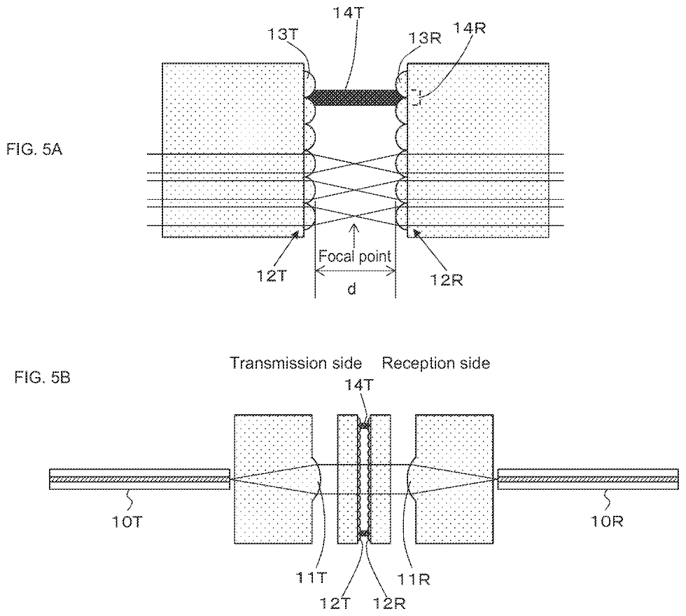

In this case, even if the protrusion 14T and the recess 14R are not aligned, as illustrated in (a) of FIG. 4, the misalignment will be corrected by the convex protrusion 14T fitting the concave recess 14R in a fitting state. Thus, in a fitting state, a distance between the facing lenses 13T and 13R exhibits a constant value d, and optical axes of the facing lenses 13T and 13R are aligned, as illustrated in (a) of FIG. 5. Note that (b) of FIG. 5 illustrates an optical coupling connector that includes an optical connector on the transmission side and an optical connector on the reception side that are in a fitting state, where the protrusion 14T is situated between the microlens array 12T on the transmission side and the microlens array 12R on the reception side.

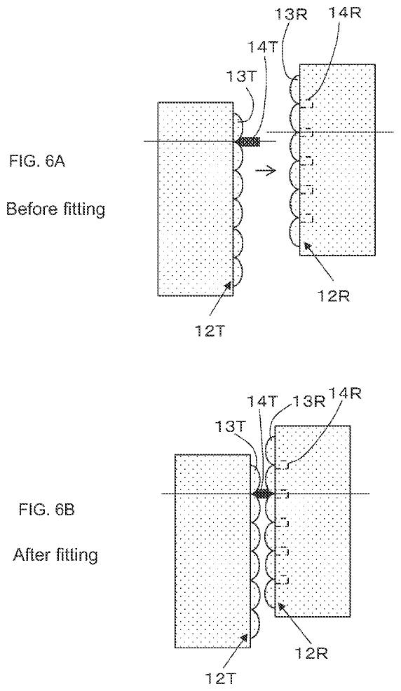

Note that the example in which there is one recess 14R on the side of the microlens array 12R for one protrusion 14T on the side of the microlens array 12T has been described above. However, there may be a plurality of recesses 14R on the side of the microlens array 12R for one protrusion 14T on the side of the microlens array 12T, as illustrated in FIG. 6. This results in being able to easily inserting the protrusion 14T into the recess 14R upon fitting even when facing connectors are not aligned by several lenses. (a) of FIG. 6 illustrates a state before fitting, and (b) of FIG. 6 illustrates a state after fitting.

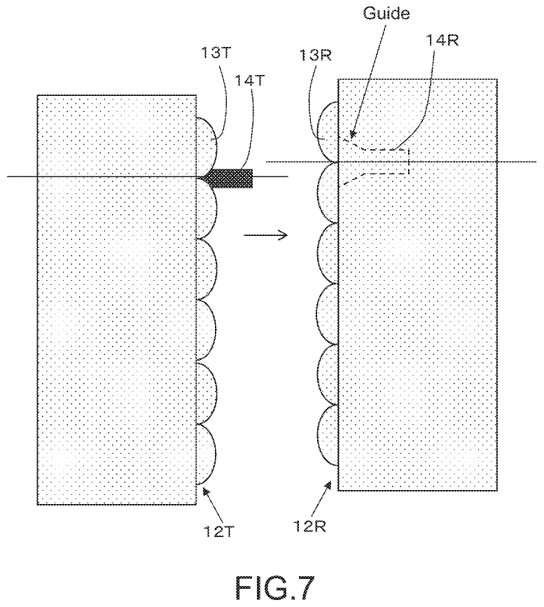

Further, a tapered portion that serves as a guide may be provided at an entrance of the recess 14R on the side of the microlens array 12R to facilitate fitting, as illustrated in FIG. 7, such that the convex protrusion 14T and the concave recess 14R fit each other without any inconvenience in a fitting state even when the protrusion 14T and the recess 14R are not aligned.

Furthermore, a floating structure may be adopted for at least one of the transmission side and the reception side, in order to correct for the position upon fitting. Moreover, the example in which the protrusion 14T is provided on the side of the microlens array 12T, and the recess 14R is provided on the side of the microlens array 12R, has been described above. However, conversely, the protrusion 14T may be provided on the side of the microlens array 12R, and the recess 14R may be provided on the side of the microlens array 12T.

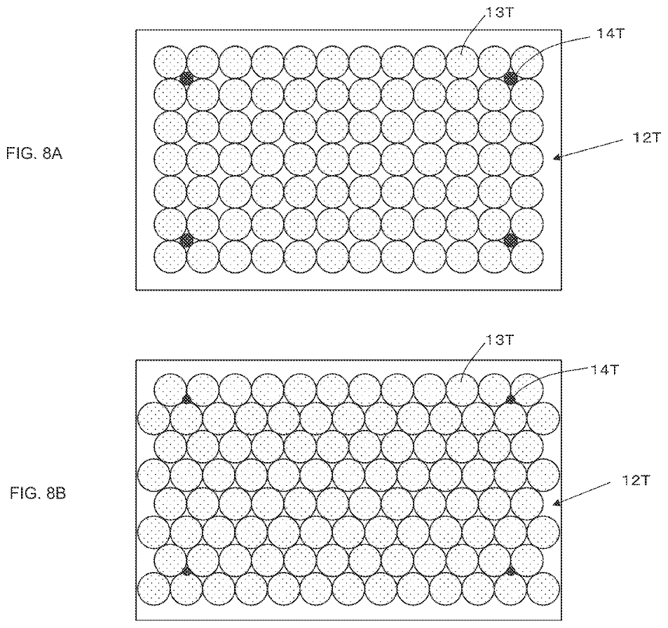

(a) and (b) of FIG. 8 illustrate examples of an arrangement of the microlens array 12T on the transmission side. However, the arrangement is not limited thereto. Note that an arrangement of the microlens array 12R on the reception side is set to be identical to the arrangement of the microlens array 12T on the transmission side. Note that the figure illustrates an example of providing four protrusions 14T. However, the number of protrusions 14T and the position of the protrusion 14T are not limited thereto.

[Examples of Configurations of Electronic Apparatus and Optical Cable]

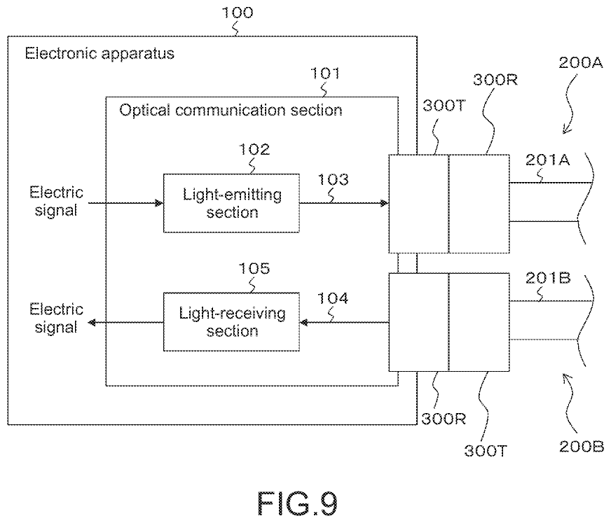

FIG. 9 illustrates examples of configurations of an electronic apparatus 100 and optical cables 200A and 200B according to embodiments. The electronic apparatus 100 includes an optical communication section 101. The optical communication section 101 includes a light-emitting section 102, an optical transmission line 103, a transmission-side optical connector 300T serving as a receptacle, a reception-side optical connector 300R serving as a receptacle, an optical transmission line 104, and a light-receiving section 105. The optical transmission line 103 and the optical transmission line 104 can each be implemented by an optical fiber.

The light-emitting section 102 includes a laser element such as a vertical-cavity surface-emitting laser (VCSEL) or a light-emitting element such as a light-emitting diode (LED) The light-emitting section 102 converts, into an optical signal, an electric signal (a transmission signal) generated by a transmission circuit (not illustrated) of the electronic apparatus 100. The optical signal emitted by the light-emitting section 102 is transmitted to the transmission-side optical connector 300T through the optical transmission line 103. Here, an optical transmitter includes the light-emitting section 102, the optical transmission line 103, and the transmission-side optical connector 300T.

An optical signal received by the reception-side optical connector 300R is transmitted to the light-receiving section 105 through the optical transmission line 104. The light-receiving section 105 includes a light-receiving element such as a photodiode. The light-receiving section 105 converts, into an electric signal (a reception signal), the optical signal transmitted by the reception-side optical connector 300R, and supplies the electric signal to a reception circuit (not illustrated) of the electronic apparatus 100. Here, an optical receiver includes the reception-side optical connector 300R, the optical transmission line 104, and the light-receiving section 105.

The optical cable 200A includes the reception-side optical connector 300R serving as a plug, and a cable body 201A. The optical cable 200A carries an optical signal coming from the electronic apparatus 100 to another electronic apparatus. The cable body 201A can be implemented by an optical fiber.

One end of the optical cable 200A is connected to the transmission-side optical connector 300T of the electronic apparatus 100 through the reception-side optical connector 300R, and the other end is connected to another electronic apparatus (not illustrated). In this case, an optical coupling connector includes the transmission-side optical connector 300T and the reception-side optical connector 300R being connected to each other.

The optical cable 200B includes the transmission-side optical connector 300T serving as a plug, and a cable body 201B. The optical cable 200B carries an optical signal coming from another electronic apparatus to the electronic apparatus 100. The cable body 201B can be implemented by an optical fiber.

One end of the optical cable 200B is connected to the reception-side optical connector 300R of the electronic apparatus 100 through the transmission-side optical connector 300T, and the other end is connected to another electronic apparatus (not illustrated). In this case, an optical coupling connector includes the transmission-side optical connector 300T and the reception-side optical connector 300R being connected to each other.

Note that examples of the electronic apparatus 100 may include mobile electronic apparatuses such as a cellular phone, a smartphone, a personal handyphone system (PHS), a PDA, a tablet PC, a laptop computer, a video camera, an IC recorder, a portable media player, an electronic organizer, an electronic dictionary, a calculator, and a portable game machine; and other electronic apparatuses such as a desktop computer, a display apparatus, a television set, a radio set, a video recorder, a printer, a car navigation system, a game machine, a router, a hub, and an optical network unit (ONU). Further, the electronic apparatus 100 may be a portion of or the entirety of an electrical appliance, or may be a portion of or the entirety of a vehicle described later. Examples of the electrical appliance include a refrigerator, a washing machine, a clock, an intercom, an air conditioner, a humidifier, an air cleaner, an illuminator, and a cooking appliance.

[Example of Configuration of Optical Connector]

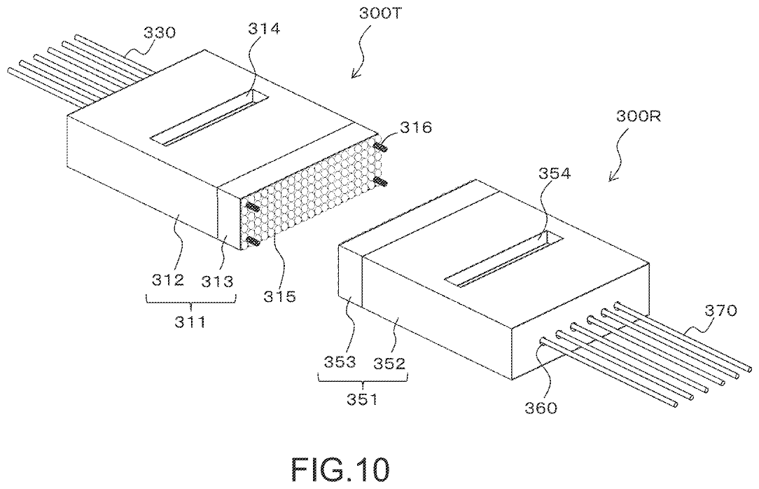

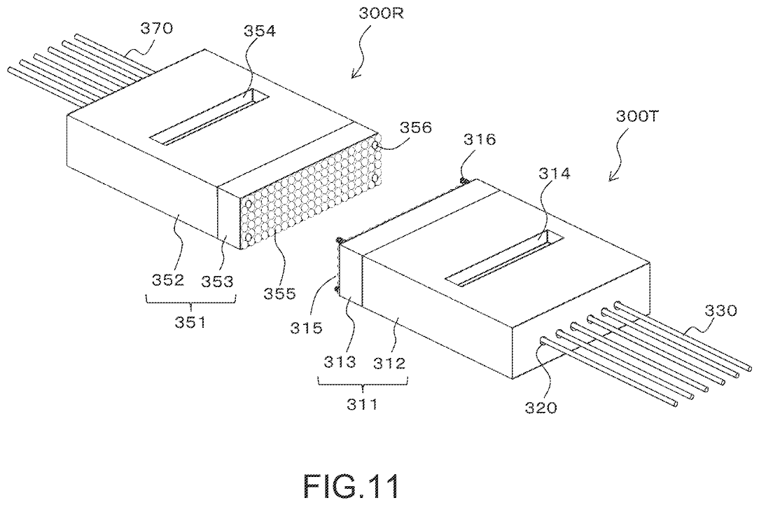

FIG. 10 is a perspective view illustrating examples of the transmission-side optical connector 300T and the reception-side optical connector 300R that are included in an optical coupling connector. FIG. 11 is also a perspective view illustrating the examples of the transmission-side optical connector 300T and the reception-side optical connector 300R, as viewed from a direction opposite to a direction from which the transmission-side optical connector 300T and the reception-side optical connector 300R are viewed in FIG. 10. The illustrated example meets a parallel transmission of optical signals of a plurality of channels. Note that the configuration that meets a parallel transmission of optical signals of a plurality of channels is illustrated here, but it is also possible to provide a configuration that meets a transmission of an optical signal of a channel, although a detailed description thereof is omitted.

The transmission-side optical connector 300T includes a connector body 311 of which an appearance has a shape of a substantially rectangular parallelepiped. The connector body 311 includes a first optical section 312 and a second optical section 313 that are connected to each other. As described above, the connector body 311 includes the first and second optical sections 312 and 313, and this makes it possible to easily perform, for example, a production of a formation lens, although such a formation lens is not illustrated in FIGS. 10 and 11.

A plurality of horizontally arranged optical fibers 330 respectively corresponding to channels is connected on the side of a rear face of the first optical section 312. In this case, ends of the respective optical fibers 330 are respectively inserted into optical fiber inserting holes 320 to fix the optical fibers 330. Here, the optical fiber 330 is included in a light emitter. Further, an adhesive injection hole 314 that includes a rectangular opening is formed on the side of an upper face of the first optical section 312. An adhesive used to fix the optical fiber 330 to the first optical section 312 is injected through the adhesive injection hole 314.

A microlens array 315 that is included in a diffusion section is formed on the side of a front face of the second optical section 313. Further, for example, cylindrical protrusions 316 are respectively provided to four corner portions on the side of the front face of the second optical section 313, each cylindrical protrusion 316 being included in a position regulator used to regulate a fitting position at which the transmission-side optical connector 300T fits the reception-side optical connector 300R. Note that the protrusion 316 is not limited to being cylindrical, and the protrusion 316 may be formed integrally with the second optical section 313.

The reception-side optical connector 300R includes a connector body 351 of which an appearance has a shape of a substantially rectangular parallelepiped. The connector body 351 includes a first optical section 352 and a second optical section 353 that are connected to each other. As described above, the connector body 351 includes the first and second optical sections 352 and 353, and this makes it possible to easily perform, for example, a production of a light collecting lens, although such a light collecting lens is not illustrated in FIGS. 10 and 11.

A plurality of horizontally arranged optical fibers 370 respectively corresponding to channels is connected on the side of a rear face of the first optical section 352. In this case, ends of the respective optical fibers 370 are respectively inserted into optical fiber inserting holes 360 to fix the optical fibers 370. Further, an adhesive injection hole 354 that includes a rectangular opening is formed on the side of an upper face of the first optical section 352. An adhesive used to fix the optical fiber 370 to the first optical section 352 is injected through the adhesive injection hole 354.

A microlens array 355 is formed on the side of a front face of the second optical section 353. Further, recesses 356 are respectively provided to four corner portions on the side of the front face of the second optical section 353, each recess 356 being included in a position regulator used to regulate a fitting position at which the reception-side optical connector 300R fits the transmission-side optical connector 300T, each recess 356 facing a corresponding one of the protrusions 316 of the transmission-side optical connector 300T. The recess 356 has a shape conforming to the protrusion 316.

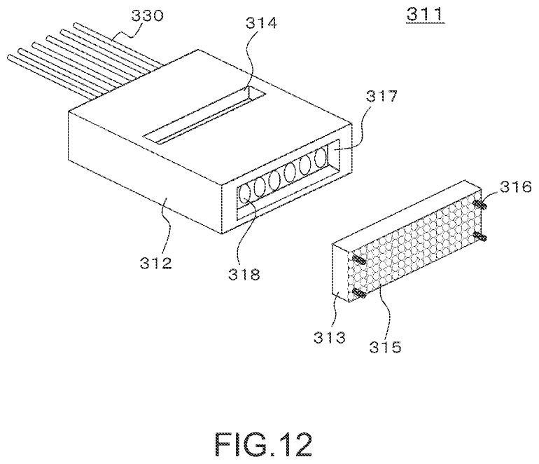

FIG. 12 is a perspective view illustrating a state in which the first optical section 312 and the second optical section 313 of the connector body 311 included in the transmission-side optical connector 300T are separated from each other. A concave light transmission space 317 that includes a rectangular opening is formed on the side of a front face of the first optical section 312, and a plurality of horizontally arranged formation lenses (convex lenses) 318 respectively corresponding to channels is formed in a bottom portion of the light transmission space 317. This prevents the surface of the lens 318 from unintendedly coming into contact with the second optical section 313 and from being damaged.

The connector body 311 is configured by the first optical section 312 and the second optical section 313 being connected to each other (refer to FIGS. 10 and 11). In this case, the light transmission space 317 formed on the side of the front face of the first optical section 312 is sealed with a rear face of the second optical section 313 to become a sealed space. Thus, the lens 318 formed on the side of the front face of the first optical section 312 is situated in the sealed space. When the lens 318 is situated in a sealed space, as described above, this makes it possible to prevent dust and dirt from being attached to the surface of the lens 318.

Note that a state in which the first optical section 352 and the second optical section 353 of the connector body 351 included in the reception-side optical connector 300R are separated from each other, is substantially similar to the above-described case of the transmission-side optical connector 300T. Thus, an illustration and a description thereof are omitted.

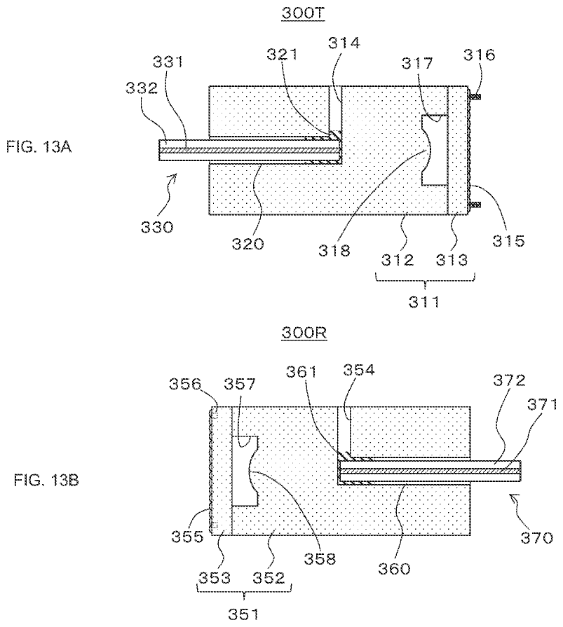

(a) of FIG. 13 is a cross-sectional view illustrating the example of the transmission-side optical connector 300T. The transmission-side optical connector 300T is further described with reference to (a) of FIG. 13.

The transmission-side optical connector 300T includes the connector body 311 configured by the first optical section 312 and the second optical section 313 being connected to each other. The first optical section 312 is made of, for example, a light-transmissive material such as synthetic resin or glass, or a material, such as silicon, through which a specific wavelength is transmitted, and the first optical section 312 is in the form of a ferrule with a lens.

It is possible to easily align optical axes of the optical fiber 330 and the lens 318 when the first optical section 312 is in the form of a ferrule with a lens, as described above. Further, when the first optical section 312 is in the form of a ferrule with a lens, as described above, a multichannel communication can be easily performed just by inserting the optical fiber 330 into the ferrule.

The concave light transmission space 317 is formed on the side of the front face of the first optical section 312. Further, the plurality of horizontally arranged lenses 318 respectively corresponding to channels is formed integrally with the first optical section 312 to be situated in the bottom portion of the light transmission space 317.

Accordingly, the accuracy in positioning the lens 318 with respect to a core 331 of the optical fiber 330 placed in the first optical section 312 can be simultaneously improved for a plurality of channels. Further, a plurality of optical fiber inserting holes 320 horizontally arranged correspondingly to the lenses 318 for the respective channels is provided to the first optical section 312, each optical fiber inserting hole 320 extending forward from the side of the rear face of the first optical section 312. The optical fiber 330 has a two-layer structure including the core 331 and cladding 332, the core 331 being a center portion that serves as a light path, the cladding 332 covering a peripheral surface of the core 331.

The optical fiber inserting hole 320 for each channel is formed such that the core 331 of the optical fiber 330 inserted into the optical fiber inserting hole 320 coincides the optical axis of a corresponding lens 318. Further, the optical fiber inserting hole 320 for each channel is formed such that a bottom of the optical fiber inserting hole 320, that is, a contact portion of the optical fiber inserting hole 320 coincides a focal point of the lens 318, the contact portion of the optical fiber inserting hole 320 being a portion with which the end (an exit end) of the optical fiber 330 is brought into contact when the optical fiber 330 is inserted into the optical fiber inserting hole 320.

Further, the adhesive injection hole 314 extending downward from the side of the upper face of the first optical section 312 is formed in the first optical section 312 such that the adhesive injection hole 314 communicates with a portion situated around the bottoms of the plurality of horizontally arranged optical fiber inserting holes 320. After the optical fiber 330 is inserted into the optical fiber inserting hole 320, an adhesive 321 is injected into a portion situated around the optical fiber 330 through the adhesive injection hole 314. This results in fixing the optical fiber 330 to the first optical section 312.

Here, if there is an airspace between the end of the optical fiber 330 and the bottom of the optical fiber inserting hole 320, light exiting the optical fiber 330 will be easily reflected off the bottom of the optical fiber inserting hole 320, and this will result in a reduction in signal quality. Thus, it is favorable that the adhesive 321 be a light-transmissive material and be injected into a space situated between the end of the optical fiber 330 and the bottom of the optical fiber inserting hole 320. This makes it possible to reduce reflection.

The second optical section 313 is made of, for example, a light-transmissive material such as synthetic resin or glass, or a material, such as silicon, through which a specific wavelength is transmitted. The connector body 311 is configured by the second optical section 313 being connected to the first optical section 312. It is favorable that the second optical section 313 be made of the same material as the first optical section 312 since a deviation of a light path due to the two optical sections being distorted when there is a thermal change, can be prevented by the two optical sections having the same coefficient of thermal expansion. However, the second optical section 313 may be made of a material different from the material of the first optical section 312.

On the side of the front face of the second optical section 313, the microlens array 315 included in a diffusion section is formed integrally with the second optical section 313. Further, the protrusions 316 are respectively formed in four corner portions on the side of the front face of the second optical section 313 to be integrated with the second optical section 313, each protrusion 316 serving as a position regulator used to regulate a fitting position at which the transmission-side optical connector 300T fits the reception-side optical connector 300R. The protrusion 316 is not limited to being formed integrally with the second optical section 313, and the formation may be performed using a pin or by another method.

As described above, the connector body 311 is configured by the first optical section 312 and the second optical section 313 being connected to each other. For example, a method including newly forming a concave portion such as a boss in one of the two optical sections, newly forming a convex portion in the other optical section, and then performing fitting; or a method including performing alignment using, for example, an image processing system, and then performing bonding and fixation may be adopted as a method for the connection described above.

In the transmission-side optical connector 300T, the lens 318 formed in the first optical section 312 operates to form light exiting the optical fiber 330 into collimated light and to cause the collimated light to exit the lens 318. Further, in the transmission-side optical connector 300T, the microlens array 315 formed in the second optical section 313 operates to cause the collimated light obtained by the formation performed by the lens 318 to diffusely exit the microlens array 315. In this case, each lens included in the microlens array 315 refracts incident collimated light such that the light passes through the focal point (refer to FIG. 3).

Accordingly, light that exits the exit end of the optical fiber 330 enters the lens 318, and is formed into collimated light, and then the collimated light exits the lens 318. Then, the collimated light exiting the lens 318 enters the microlens array 315, and diffusely exits the microlens array 315.

(b) of FIG. 13 is a cross-sectional view illustrating the example of the reception-side optical connector 300R. The reception-side optical connector 300R is further described with reference to (b) of FIG. 13.

The reception-side optical connector 300R includes the connector body 351 configured by the first optical section 352 and the second optical section 353 being connected to each other. The first optical section 352 is made of, for example, a light-transmissive material such as synthetic resin or glass, or a material, such as silicon, through which a specific wavelength is transmitted, and the first optical section 352 is in the form of a ferrule with a lens.

It is possible to easily align optical axes of the optical fiber 370 and a lens 358 when the first optical section 352 is in the form of a ferrule with a lens, as described above. Further, when the first optical section 352 is in the form of a ferrule with a lens, as described above, a multichannel communication can be easily performed just by inserting the optical fiber 370 into the ferrule.

A concave light transmission space 357 is formed on the side of a front face of the first optical section 352. Further, a plurality of horizontally arranged lenses 358 respectively corresponding to channels is formed integrally with the first optical section 352 to be situated in a bottom portion of the light transmission space 357.

Accordingly, the accuracy in positioning the lens 358 with respect to a core 371 of the optical fiber 370 placed in the first optical section 352 can be simultaneously improved for a plurality of channels. Further, a plurality of optical fiber inserting holes 360 horizontally arranged correspondingly to the lenses 358 for the respective channels is provided to the first optical section 352, each optical fiber inserting hole 360 extending forward from the side of the rear face of the first optical section 352. The optical fiber 370 has a two-layer structure including the core 371 and cladding 372, the core 371 being a center portion that serves as a light path, the cladding 372 covering a peripheral surface of the core 371.

The optical fiber inserting hole 360 for each channel is formed such that the core 371 of the optical fiber 370 inserted into the optical fiber inserting hole 360 coincides the optical axis of a corresponding lens 358. Further, the optical fiber inserting hole 360 for each channel is formed such that a bottom of the optical fiber inserting hole 360, that is, a contact portion of the optical fiber inserting hole 360 coincides a focal point of the lens 358, the contact portion of the optical fiber inserting hole 360 being a portion with which the end (an entrance end) of the optical fiber 370 is brought into contact when the optical fiber 370 is inserted into the optical fiber inserting hole 360.

Further, the adhesive injection hole 354 extending downward from the side of the upper face of the first optical section 352 is formed in the first optical section 352 such that the adhesive injection hole 354 communicates with a portion situated around the bottoms of the plurality of horizontally arranged optical fiber inserting holes 360. After the optical fiber 370 is inserted into the optical fiber inserting hole 360, an adhesive 361 is injected into a portion situated around the optical fiber 370 through the adhesive injection hole 354. This results in fixing the optical fiber 370 to the first optical section 352.

The second optical section 353 is made of, for example, a light-transmissive material such as synthetic resin or glass, or a material, such as silicon, through which a specific wavelength is transmitted. The connector body 351 is configured by the second optical section 353 being connected to the first optical section 352. It is favorable that the second optical section 353 be made of the same material as the first optical section 352 since a deviation of a light path due to the two optical sections being distorted when there is a thermal change, can be prevented by the two optical sections having the same coefficient of thermal expansion. However, the second optical section 353 may be made of a material different from the material of the first optical section 352.

On the side of the front face of the second optical section 353, the microlens array 355 included in a diffusion section is formed integrally with the second optical section 353. Further, the recesses 356 are respectively formed in four corner portions on the side of the front face of the second optical section 353 to be integrated with the second optical section 353, each recess 356 serving as a position regulator used to regulate a fitting position at which the reception-side optical connector 300R fits the transmission-side optical connector 300T.

As described above, the connector body 351 is configured by the first optical section 352 and the second optical section 353 being connected to each other. For example, a method including newly forming a concave portion such as a boss in one of the two optical sections, newly forming a convex portion in the other optical section, and then performing fitting; or a method including performing alignment using, for example, an image processing system, and then performing bonding and fixation may be adopted as a method for the connection described above.

In the reception-side optical connector 300R, the microlens array 355 formed in the second optical section 353 operates to re-form, into collimated light, light diffused by the microlens array 315 on the transmission side, and to cause the collimated light to exit the microlens array 355. Further, the lens 358 formed in the first optical section 352 operates to collect the collimated light obtained by the re-formation performed by the microlens array 355, and to cause the collected collimated light to enter the optical fiber 370.

Accordingly, light exiting the microlens array 315 of the transmission-side optical connector 300T enters the microlens array 355 to be re-formed into collimated light by the microlens array 355, and the collimated light exits the microlens array 355. Then, the collimated light exiting the microlens array 355 is collected by the lens 358 to enter the optical fiber 370.

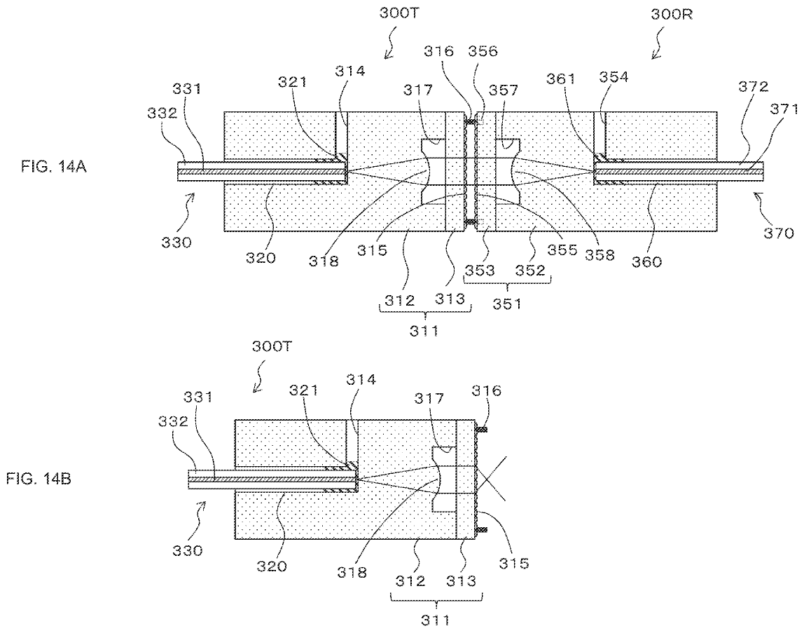

(a) of FIG. 14 illustrates the transmission-side optical connector 300T and the reception-side optical connector 300R in a fitting (connected) state. In this state, an end of the protrusion 316 on the side of the microlens array 315 is inserted into the recess 356 on the side of the microlens array 355. Accordingly, a distance between a lens of the microlens array 315 and a lens of the microlens array 355 that face each other exhibits a constant value d, and optical axes of the facing lenses are aligned (refer to FIG. 5).

In the transmission-side optical connector 300T, light transmitted through the optical fiber 330 exits the exit end of the optical fiber 330 with a specified NA. The exiting light enters the lens 318, and is formed into collimated light, and then the collimated light exits the lens 318. Then, the light exiting the lens 318 enters, and diffusely exits the microlens array 315.

Further, in the reception-side optical connector 300R, light exiting the transmission-side optical connector 300T enters the microlens array 355, and is re-formed into collimated light by the microlens array 355, and then the collimated light exits the microlens array 355. The light exiting the microlens array 355 enters the lens 358 to be collected by the lens 358. Then, the collected light enters the entrance end of the optical fiber 370, and is transmitted through the optical fiber 370.

When the transmission-side optical connector 300T and the reception-side optical connector 300R are in a fitting state, as described above, light exiting the optical fiber 330 on the transmission side enters the optical fiber 370 on the reception side. This makes it possible to perform an optical communication.

(b) of FIG. 14 illustrates the transmission-side optical connector 300T in a non-fitting (unconnected) state. In this case, light transmitted through the optical fiber 330 exits the exit end of the optical fiber 330 with a specified NA. The exiting light enters the lens 318, and is formed into collimated light, and then the collimated light exits the lens 318. Then, the light exiting the lens 318 enters the microlens array 315, and diffusely exits the microlens array 315. In other words, light exiting the transmission-side optical connector 300T is diffused light. This results in satisfactorily preventing a laser hazard caused in a non-fitting state.

In the transmission-side optical connector 300T of the optical coupling connector configured as described above, light exits the optical fiber 330, and is formed into collimated light by the lens 318. The collimated light enters the microlens array 315, and diffusely exits the microlens array 315. Thus, light that exits in a non-fitting state is diffused. This results in preventing a laser hazard caused in a non-fitting state using a simple structure.

Note that the effects described herein are not limitative but are merely illustrative, and additional effects may be provided.

### Another Configuration Example 1

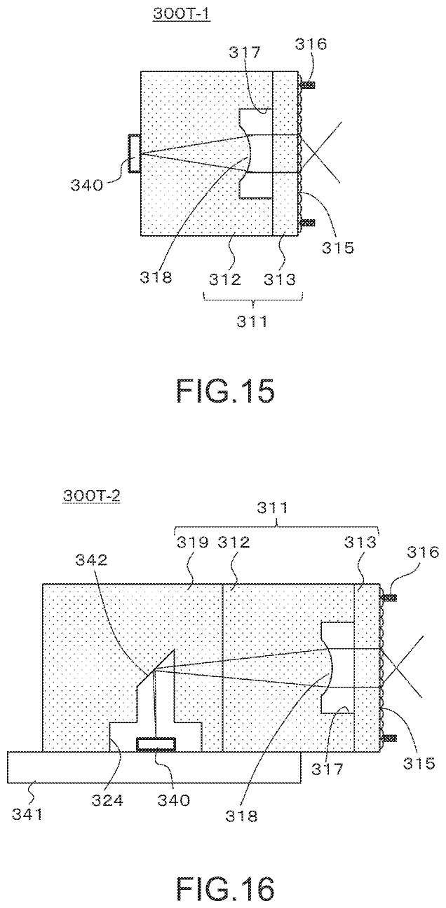

FIG. 15 is a cross-sectional view illustrating a transmission-side optical connector 300T-1 of another configuration example 1. In FIG. 15, a portion corresponding to a portion of (b) of FIG. 14 is denoted by the same reference numeral as the portion of (b) of FIG. 14, and a detailed description thereof is omitted as appropriate. In the transmission-side optical connector 300T-1, a light emitter fixed to the first optical section 312 is not the optical fiber 330, but a light-emitting element 340 such as a vertical-cavity surface-emitting laser (VCSEL).

In this case, a plurality of light-emitting elements 340 horizontally arranged correspondingly to the lenses 318 for the respective channels is fixed on the side of the rear face of the first optical section 312. Further, in this case, the light-emitting element 340 for each channel is fixed such that an exit portion of the light-emitting element 340 coincides the optical axis of a corresponding lens 318. Furthermore, in this case, the thickness and the like in an optical-axis direction of the first optical section 312 are set such that the exit portion of the light-emitting element 340 for each channel coincides the focal point of the corresponding lens 318.

As in the case of the transmission-side optical connector 300T of (b) of FIG. 14, in the transmission-side optical connector 300T-1 in a non-fitting (unconnected) state, light exiting the exit portion of the light-emitting element 340 with a specified NA enters the lens 318, and is formed into collimated light. Thereafter, the collimated light enters the microlens array 315, and diffusely exits the microlens array 315. This results in satisfactorily preventing a laser hazard caused in a non-fitting state.

When the light-emitting element 340 is fixed to the first optical section 312, as described above, this results in there being no need for an optical fiber upon transmitting an optical signal coming from the light-emitting element 340. This makes it possible to reduce costs.

### Another Configuration Example 2

FIG. 16 is a cross-sectional view illustrating a transmission-side optical connector 300T-2 of another configuration example 2. In FIG. 16, a portion corresponding to a portion of (b) of FIG. 14 or FIG. 15 is denoted by the same reference numeral as the portion of (b) of FIG. 14 or FIG. 15, and a detailed description thereof is omitted as appropriate. In the transmission-side optical connector 300T-2, the connector body 311 includes the first optical section 312, the second optical section 313, and a third optical section 319. The third optical section 319 is connected on the side of the rear face of the first optical section 312.

In the transmission-side optical connector 300T-2, a substrate 341 on which the light-emitting element 340 is placed is fixed on the side of a lower face of the connector body 311. In this case, a plurality of light-emitting elements 340 horizontally arranged correspondingly to the lenses 318 for the respective channels is placed on the substrate 341.

A light-emitting-element arranging hole 324 extending upward from the side of a lower face of the third optical section 319 is formed in the third optical section 319. Further, in order to change a path of light coming from the light-emitting element 340 for each channel, such that the light path is oriented toward a direction of a corresponding lens 318, a bottom portion of the light-emitting-element arranging hole 324 includes an inclined surface, and a mirror 342 is arranged on the inclined surface. Note that the mirror 342 is not limited to being separately generated and being fixed on the inclined surface, and the mirror 342 may be formed on the inclined surface by, for example, vapor deposition.

Here, the position of the substrate 341 is adjusted and the substrate 341 is fixed, such that the exit portion of the light-emitting element 340 for each channel coincides the optical axis of a corresponding lens 318. Further, in this case, the position at which the lens 318 is formed, the position at which the light-emitting-element arranging hole 324 is formed, the length of the light-emitting-element arranging hole 324, and the like are set such that the exit portion of the light-emitting element 340 for each channel coincides the focal point of the corresponding lens 318.

In the transmission-side optical connector 300T-2 in a non-fitting (unconnected) state, a path of light exiting the exit portion of the light-emitting element 340 with a specified NA is changed by the mirror 342. Then, as in the case of the transmission-side optical connector 300T of (b) of FIG. 14, the light enters the lens 318, and is formed into collimated light. Thereafter, the collimated light enters the microlens array 315, and diffusely exits the microlens array 315. This results in satisfactorily preventing a laser hazard caused in a non-fitting state.

When the substrate 341 on which the light-emitting element 340 is placed is fixed to the connector body 311, as described above, this results in there being no need for an optical fiber upon transmitting an optical signal coming from the light-emitting element 340. This makes it possible to reduce costs. Further, a path of light coming from the light-emitting element 340 placed on the substrate 341 is changed by the mirror 342 to cause the light to enter the lens 318. This results in easily performing implementation, and thus in being able to increase a degree of freedom in design.

In general, it is difficult to perform implementation when the light-emitting element 340 is mounted on the first optical section 312 that is a lens component, as in the case of FIG. 15. However, when the mirror 342 is provided, as illustrated in FIG. 16, the light-emitting element 340 can be placed on the substrate 341. This results in being able to increase a degree of freedom in design, such as an easy implementation.

### Another Configuration Example 3

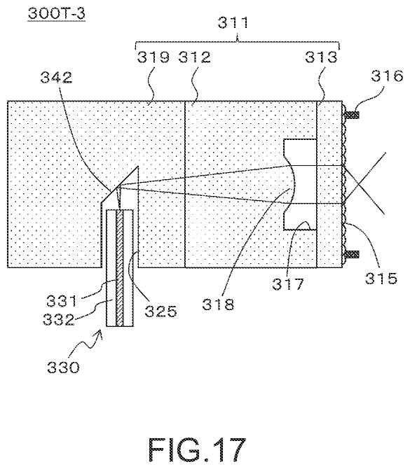

FIG. 17 is a cross-sectional view illustrating a transmission-side optical connector 300T-3 of another configuration example 3. In FIG. 17, a portion corresponding to a portion of (b) of FIG. 14 or FIG. 16 is denoted by the same reference numeral as the portion of (b) of FIG. 14 or FIG. 16, and a detailed description thereof is omitted as appropriate. In the transmission-side optical connector 300T-3, a plurality of optical fiber inserting holes 325 horizontally arranged correspondingly to the lenses 318 for the respective channels is formed in the third optical section 319, each optical fiber inserting hole 325 extending upward from the side of the lower face of the third optical section 319.

In order to change a path of light coming from the optical fiber 330 inserted into the optical fiber inserting hole 325, such that the light path is oriented toward a direction of a corresponding lens 318, a bottom portion of each optical fiber inserting hole 325 includes an inclined surface, and the mirror 342 is arranged on the inclined surface. Further, each optical fiber inserting hole 325 is formed such that the core 331 of the optical fiber 330 inserted into the optical fiber inserting hole 325 coincides the optical axis of the corresponding lens 318.

The optical fiber 330 for each channel is inserted into a corresponding optical fiber inserting hole 325, and, for example, an adhesive (not illustrated) is injected into a portion situated around the optical fiber 330. This results in fixing the optical fiber 330. In this case, the position of inserting the optical fiber 330 is set such that the end (the exit end) of the optical fiber 330 coincides the focal point of a corresponding lens 318, that is, such that the end (the exit end) of the optical fiber 330 is situated at a certain distance from the mirror 342.

In the transmission-side optical connector 300T-3, a path of light exiting the exit end of the optical fiber 330 with a specified NA is changed by the mirror 342. Then, as in the case of the transmission-side optical connector 300T of (b) of FIG. 14, the light enters the lens 318, and is formed into collimated light. Thereafter, the collimated light enters the microlens array 315, and diffusely exits the microlens array 315. This results in satisfactorily preventing a laser hazard caused in a non-fitting state.

In this configuration example, the third optical section 319 is in the form of a ferrule. This makes it possible to easily align the optical axes of the optical fiber 330 and the lens 318. Further, in this configuration example, a path of light coming from the optical fiber 330 is changed by the mirror 342. This results in easily performing implementation, and thus in being able to increase a degree of freedom in design.

### Another Configuration Example 4

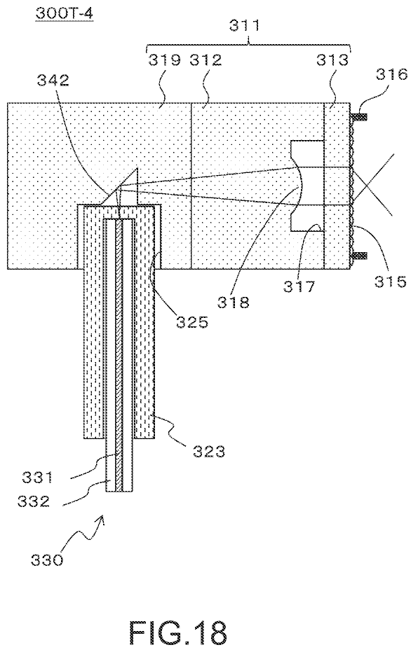

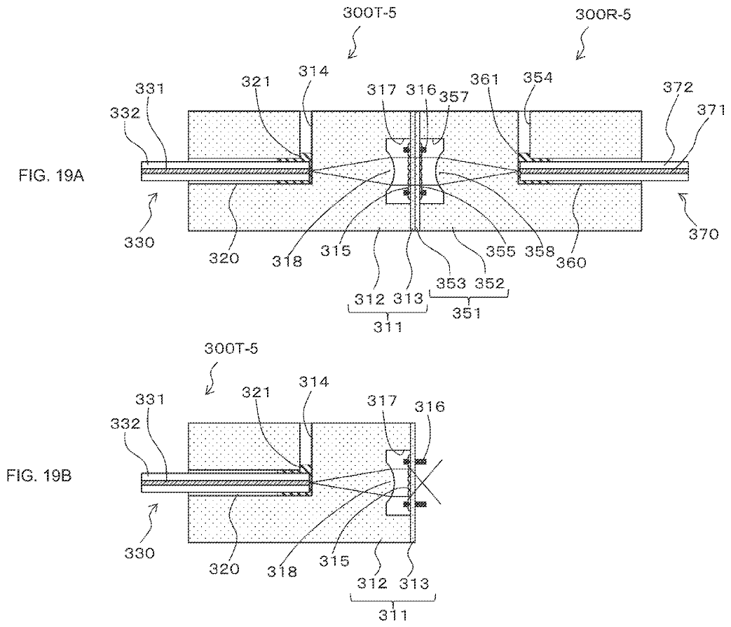

FIG. 18 is a cross-sectional view illustrating a transmission-side optical connector 300T-4 of another configuration example 4. In FIG. 18, a portion corresponding to a portion of (b) of FIG. 14 or FIG. 17 is denoted by the same reference numeral as the portion of (b) of FIG. 14 or FIG. 17, and a detailed description thereof is omitted as appropriate. In the transmission-side optical connector 300T-4, the diameter of the optical fiber inserting hole 325 formed in the third optical section 319 is increased. Further, a ferrule 323 is inserted into the optical fiber inserting hole 325 to be fixed to the optical fiber inserting hole 325 using, for example, an adhesive (not illustrated), where the optical fiber 330 in a state of abutting on the ferrule 323 is fixed to the ferrule 323 in advance. Such a configuration makes it easy to keep the end of the optical fiber 330 at a certain distance from the mirror 342.

### Another Configuration Example 5

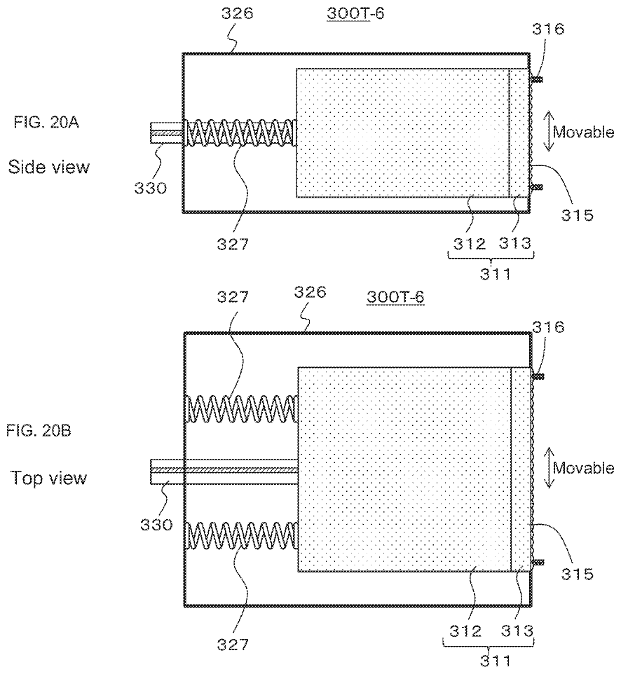

(a) and (b) of FIG. 19 are cross-sectional views illustrating a transmission-side optical connector 300T-5 and a reception-side optical connector 300R-5 of another configuration example 5. In (a) and (b) of FIG. 19, a portion corresponding to a portion of (a) or (b) of FIG. 14 is denoted by the same reference numeral as the portion of (a) or (b) of FIG. 14, and a detailed description thereof is omitted as appropriate. In the transmission-side optical connector 300T-5, the second optical section 313 is connected to the first optical section 312 such that a convex surface of each lens of the microlens array 315 formed in the second optical section 313 faces the lens 318.

Likewise, in the reception-side optical connector 300R-5, the second optical section 353 is connected to the first optical section 352 such that a convex surface of each lens of the microlens array 355 formed in the second optical section 353 faces the lens 358. In this case, an end surface of the connector body 311 and an end surface of the connector body 351 that face each other are flat. This makes it possible to easily perform cleaning when, for example, dust is attached.

(a) of FIG. 19 illustrates the transmission-side optical connector 300T-5 and the reception-side optical connector 300R-5 in a fitting (connected) state. In this state, the protrusion 316 on the side of the microlens array 315 is inserted into a through-hole that is a position regulator (not illustrated) on the side of the microlens array 355. Accordingly, a distance between a lens of the microlens array 315 and a lens of the microlens array 355 that face each other exhibits a constant value d, and optical axes of the facing lenses are aligned (refer to FIG. 5).

In the transmission-side optical connector 300T-5, light transmitted through the optical fiber 330 exits the exit end of the optical fiber 330 with a specified NA. The exiting light enters the lens 318, and is formed into collimated light, and then the collimated light exits the lens 318. Then, the light exiting the lens 318 enters the microlens array 315, and diffusely exits the microlens array 315.

Further, in the reception-side optical connector 300R-5, light exiting the transmission-side optical connector 300T-5 enters the microlens array 355, and is re-formed into collimated light by the microlens array 355, and then the collimated light exits the microlens array 355. The light exiting the microlens array 355 enters the lens 358 to be collected by the lens 358. Then, the collected light enters the entrance end of the optical fiber 370, and is transmitted through the optical fiber 370.

When the transmission-side optical connector 300T-5 and the reception-side optical connector 300R-5 are in a fitting state, as described above, light exiting the optical fiber 330 on the transmission side enters the optical fiber 370 on the reception side. This makes it possible to perform an optical communication.

(b) of FIG. 19 illustrates the transmission-side optical connector 300T-5 in a non-fitting (unconnected) state. In this case, light transmitted through the optical fiber 330 exits the exit end of the optical fiber 330 with a specified NA. The exiting light enters the lens 318, and is formed into collimated light, and then the collimated light exits the lens 318. Then, the light exiting the lens 318 enters the microlens array 315, and diffusely exits the microlens array 315. In other words, light exiting the transmission-side optical connector 300T-5 is diffused light. This results in satisfactorily preventing a laser hazard caused in a non-fitting state.

### Another Configuration Example 6

(a) and (b) of FIG. 20 are a side view and a top view each illustrating a transmission-side optical connector 300T-6 of another configuration example 6. In (a) and (b) of FIG. 20, a portion corresponding to a portion of (a) of FIG. 13 is denoted by the same reference numeral as the portion of (a) of FIG. 13, and a detailed description thereof is omitted as appropriate. In the transmission-side optical connector 300T-6, the connector body 311 is held in a floating state in a connector external housing 326 using a holding section that is a spring member 327 in this case.

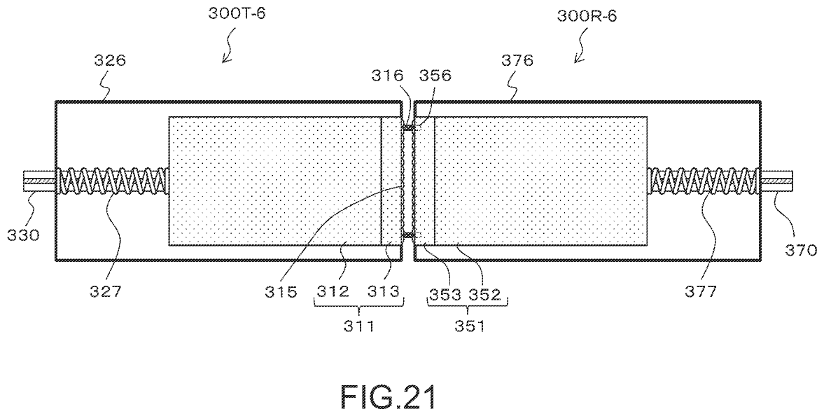

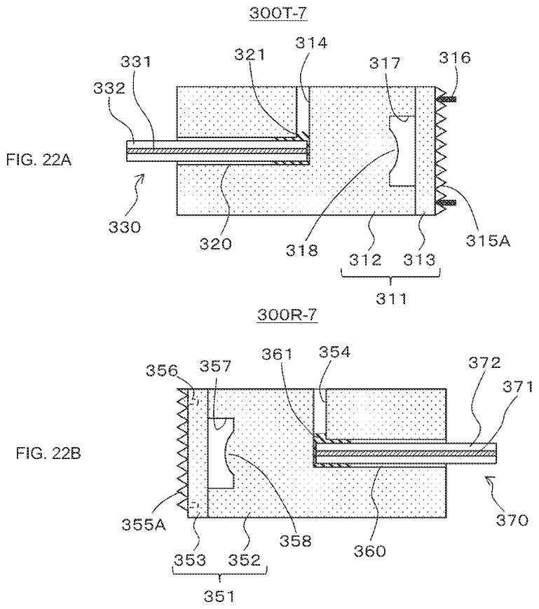

FIG. 21 illustrates the transmission-side optical connector 300T-6 and a reception-side optical connector 300R-6 in a fitting (connected) state. As in the case of the transmission-side optical connector 300T-6 described above, in the reception-side optical connector 300R-6, the connector body 351 is held in a floating state in a connector external housing 376 using a holding section that is a spring member 377 in this case. A detailed description thereof is omitted.

When the connector body 311 of the transmission-side optical connector 300T-6 and the connector body 351 of the reception-side optical connector 300R-6 are each movable by being held in a floating state in a corresponding connector external housing, as described above, this makes it easy to correct for the position in a fitting state. Note that the floating structure is not limited to this example. Further, the floating structure may be used in one of the transmission side and the reception side, not in both of them.

### Another Configuration Example 7

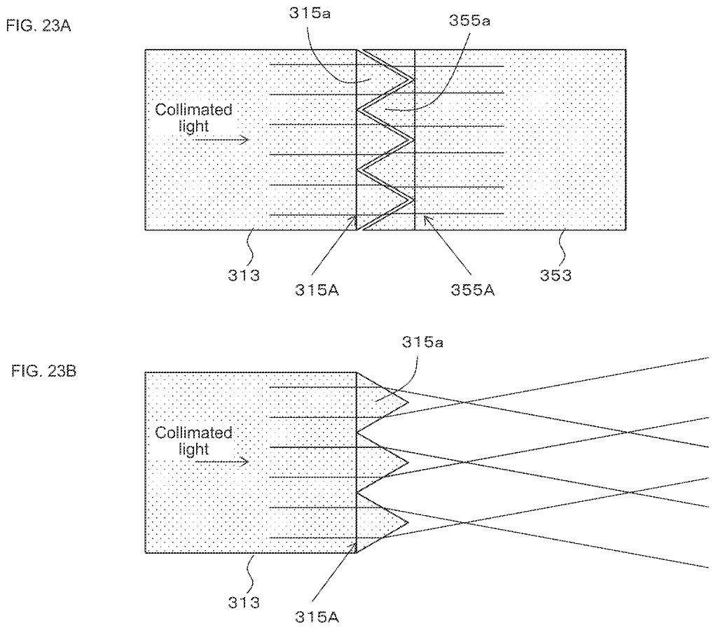

(a) and (b) of FIG. 22 are cross-sectional views respectively illustrating a transmission-side optical connector 300T-7 and a reception-side optical connector 300R-7 of another configuration example 7. In (a) and (b) of FIG. 22, a portion corresponding to a portion of (a) or (b) of FIG. 13 is denoted by the same reference numeral as the portion of (a) or (b) of FIG. 13, and a detailed description thereof is omitted as appropriate.

The transmission-side optical connector 300T-7 illustrated in (a) of FIG. 22 includes the connector body 311 configured by the first optical section 312 and the second optical section 313 being connected to each other. On the side of the front face of the second optical section 313, a diffusion plate (a prism sheet or a microprism array) 315A that is included in a diffusion section is formed integrally with the second optical section 313. Further, the protrusions 316 are respectively formed in the four corner portions on the side of the front face of the second optical section 313 to be integrated with the second optical section 313, each protrusion 316 serving as a position regulator used to regulate a fitting position at which the transmission-side optical connector 300T-7 fits the reception-side optical connector 300R-7.

Regarding the other points, the transmission-side optical connector 300T-7 has a configuration similar to the configuration of the transmission-side optical connector 300T of (a) of FIG. 13.

In the transmission-side optical connector 300T-7, the lens 318 formed in the first optical section 312 operates to form light exiting the optical fiber 330 into collimated light and to cause the collimated light to exit. Further, in the transmission-side optical connector 300T-7, the diffusion plate 315A formed in the second optical section 313 operates to cause the collimated light obtained by the formation performed by the lens 318 to diffusely exit the diffusion plate 315A. In this case, each prism included in the diffusion plate 315A refracts incident collimated light such that the light is converged.

Accordingly, light that exits the exit end of the optical fiber 330 enters the lens 318, and is formed into collimated light, and then the collimated light exits the lens 318. Then, the collimated light exiting the lens 318 enters the diffusion plate 315A, and diffusely exits the diffusion plate 315A.

The reception-side optical connector 300R-7 illustrated in (b) of FIG. 22 includes the connector body 351 configured by the first optical section 352 and the second optical section 353 being connected to each other. On the side of the front face of the second optical section 353, a diffusion plate (a prism sheet or a microprism array) 355A that is included in a diffusion section is formed integrally with the second optical section 353. Further, the recesses 356 are respectively formed in the four corner portions on the side of the front face of the second optical section 353 to be integrated with the second optical section 353, each recess 356 serving as a position regulator used to regulate a fitting position at which the reception-side optical connector 300R-7 fits the transmission-side optical connector 300T-7.

Regarding the other points, the reception-side optical connector 300R-7 has a configuration similar to the configuration of the reception-side optical connector 300R of (b) of FIG. 13.

In the reception-side optical connector 300R-7, the diffusion plate 355A formed in the second optical section 353 operates to re-form, into collimated light, light diffused by the diffusion plate 315A on the transmission side, and to cause the collimated light to exit. Further, the lens 358 formed in the first optical section 352 operates to collect the collimated light obtained by the re-formation performed by the microlens array 355, and to cause the collected collimated light to enter the optical fiber 370.

Accordingly, light exiting the diffusion plate 315A of the transmission-side optical connector 300T-7 enters the diffusion plate 355A to be re-formed into collimated light by the diffusion plate 355A, and the collimated light exits the diffusion plate 355A. Then, the collimated light exiting the diffusion plate 355A is collected by the lens 358 to enter the optical fiber 370.

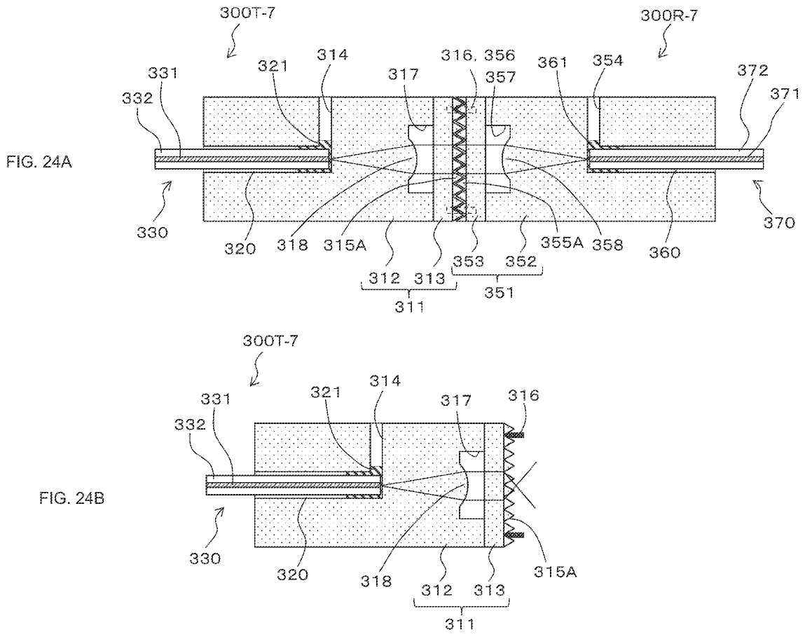

(a) of FIG. 23 illustrates how the diffusion plates 315A and 355A operate in a fitting state. A prism 315a that is included in the diffusion plate 315A on the transmission side refracts incident collimated light such that the light is converged, and causes the light to diffusely exit the diffusion plate 315A. Further, a prism 355a that is included in the diffusion plate 355A on the reception side refracts incident light to re-form the light into collimated light, and causes the collimated light to exit the diffusion plate 355A. In this case, light moves in parallel by a gap between the diffusion plates 315A and 355A to be transmitted to the reception side in the form of collimated light.

(b) of FIG. 23 illustrates how the diffusion plate 315A on the transmission side operates in a non-fitting state. 355a included in the diffusion plate 355A refracts incident collimated light such that the light is converged, and causes the light to diffusely exit the diffusion plate 355A. Thus, light exiting the diffusion plate 315A is diffused light.

Here, in order to cause the diffusion plates 315A and 355A to operate as illustrated in (a) of FIG. 23, the protrusion 316 provided on the side of the diffusion plate 315A and the recess 356 formed on the side of the diffusion plate 355A fit each other to align the diffusion plates 315A and 355A facing each other with respect to axes of X, Y, and Z.

(a) of FIG. 24 illustrates the transmission-side optical connector 300T-7 and the reception-side optical connector 300R-7 in a fitting (connected) state. In this state, the end of the protrusion 316 on the side of the diffusion plate 315A is inserted into the recess 356 on the side of the diffusion plate 355A. Accordingly, a gap occurs between the diffusion plates 315A and 355A in which a distance between a prism of the diffusion plate 315A and a prism of the diffusion plate 355A that face each other is constant, and the diffusion plates 315A and 355A fit each other (refer to (3) of FIG. 23).

In the transmission-side optical connector 300T-7, light transmitted through the optical fiber 330 exits the exit end of the optical fiber 330 with a specified NA. The exiting light enters the lens 318, and is formed into collimated light, and then the collimated light exits the lens 318. Then, the light exiting the lens 318 enters, and diffusely exits the diffusion plate 315A.

Further, in the reception-side optical connector 300R-7, light exiting the transmission-side optical connector 300T-7 enters the diffusion plate 355A, and is re-formed into collimated light by the diffusion plate 355A, and then the collimated light exits the diffusion plate 355A. The light exiting the diffusion plate 355A enters the lens 358 to be collected by the lens 358. Then, the collected light enters the entrance end of the optical fiber 370, and is transmitted through the optical fiber 370.

When the transmission-side optical connector 300T-7 and the reception-side optical connector 300R-7 are in a fitting state, as described above, light exiting the optical fiber 330 on the transmission side enters the optical fiber 370 on the reception side. This makes it possible to perform an optical communication.

(b) of FIG. 24 illustrates the transmission-side optical connector 300T-7 in a non-fitting (unconnected) state. In this case, light transmitted through the optical fiber 330 exits the exit end of the optical fiber 330 with a specified NA. The exiting light enters the lens 318, and is formed into collimated light, and then the collimated light exits the lens 318. Then, the light exiting the lens 318 enters the diffusion plate 315A, and diffusely exits the diffusion plate 315A. In other words, light exiting the transmission-side optical connector 300T-7 is diffused light. This results in satisfactorily preventing a laser hazard caused in a non-fitting state.

### 2. Modifications

The optical fiber may be a single-mode optical fiber or a multimode optical fiber, although this is not described above. Further, the NA is not limited to a specific NA. Furthermore, the mirror in the embodiments described above may be implemented by another light path changing section. For example, a light path changing section that performs total reflection using difference in refractive index may be adopted.

The example in which the lens 318 forms light into collimated light has been described in the embodiments above. However, the configuration is not limited thereto.

The favorable embodiments of the present disclosure have been described above in detail with reference to the accompanying drawings. However, the technical scope of the present disclosure is not limited to these examples. It is clear that persons who have common knowledge in the technical field of the present disclosure could conceive various alterations or modifications within the scope of a technical idea according to an embodiment of the present disclosure. It is understood that of course such alterations or modifications also fall under the technical scope of the present disclosure.

Further, the effects described herein are not limitative, but are merely descriptive or illustrative. In other words, the technology according to the present disclosure may provide other effects apparent to those skilled in the art from the description herein, in addition to, or instead of the effects described above.

Note that the present technology may also take the following configurations.

(1) An optical connector, including

a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

(2) The optical connector according to (1), in which

the diffusion section includes a microlens array.

(3) The optical connector according to (2), in which

the microlens array is arranged such that a convex surface of each microlens faces the lens.

(4) The optical connector according to (1), in which

the diffusion section includes a diffusion plate.

(5) The optical connector according to any one of (1) to (4), in which

the connector body includes a first optical section that includes the lens, and a second optical section that includes the diffusion section.

(6) The optical connector according to any one of (1) to (5), further including

a holding section that holds the connector body in a floating state in a connector external housing.

(7) The optical connector according to any one of (1) to (6), further including

a position regulator that regulates a fitting position at which the connector body fits a connector that faces the optical connector.

(8) The optical connector according to any one of (1) to (7), in which

the lens forms the light exiting the light emitter into collimated light.

(9) The optical connector according to any one of (1) to (8), in which

the light emitter is an optical fiber, and

the connector body includes an insertion hole into which the optical fiber is inserted.

(10) The optical connector according to (1) to (8), in which

the light emitter is a light-emitting element that converts an electric signal into an optical signal.

(11) The optical connector according to (10), in which

the light emitter is connected to the connector body, and

the light exiting the light emitter enters the lens with no change in a path of the light.

(12) The optical connector according to (10), in which

the connector body includes a light path changing section used to change a light path, and

a path of the light exiting the light emitter is changed by the light path changing section to cause the light to enter the lens.

(13) The optical connector according to any one of (1) to (12), in which

the connector body is made of a light-transmissive material, and integrally includes the lens.

(14) The optical connector according to any one of (1) to (13), in which

the connector body includes a plurality of the lenses.

(15) The optical connector according to any one of (1) to (14), further including the light emitter.
(16) An optical cable, including

an optical connector that serves as a plug, the optical connector including a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

(17) An electronic apparatus, including

an optical connector that serves as a receptacle, the optical connector including a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

### REFERENCE SIGNS LIST

100 electronic apparatus
101 optical communication section
102 light-emitting section
103, 104 optical transmission line
105 light-receiving section
200A, 200B optical cable
201A, 201B cable body
300T, 300T-1 to 300T-7 transmission-side optical connector
300R, 300R-5 to 300R-7 reception-side optical connector
311 connector body
312 first optical section
313 second optical section
314 adhesive injection hole
315 microlens array
315A diffusion plate
315a prism
316 protrusion
317 light transmission space
318 lens
319 third optical section
320 optical fiber inserting hole
321 adhesive
323 ferrule
324 light-emitting-element arranging hole
325 optical fiber inserting hole
326 connector external housing
327 spring member
330 optical fiber
331 core
332 cladding
340 light-emitting element
341 substrate
342 mirror
351 connector body
352 first optical section
353 second optical section
354 adhesive injection hole
355 microlens array
355A diffusion plate
355a prism
356 recess
357 light transmission space
358 lens
360 optical fiber inserting hole
361 adhesive
370 optical fiber
371 core
372 cladding
376 connector external housing
377 spring member

1. An optical connector, comprising
a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

2. The optical connector according to claim 1, wherein
the diffusion section includes a microlens array.

3. The optical connector according to claim 2, wherein
the microlens array is arranged such that a convex surface of each microlens faces the lens.

4. The optical connector according to claim 1, wherein
the diffusion section includes a diffusion plate.

5. The optical connector according to claim 1, wherein
the connector body includes a first optical section that includes the lens, and a second optical section that includes the diffusion section.

6. The optical connector according to claim 1, further comprising
a holding section that holds the connector body in a floating state in a connector external housing.

7. The optical connector according to claim 1, further comprising
a position regulator that regulates a fitting position at which the connector body fits a connector that faces the optical connector.

8. The optical connector according to claim 1, wherein
the lens forms the light exiting the light emitter into collimated light.

9. The optical connector according to claim 1, wherein
the light emitter is an optical fiber, and
the connector body includes an insertion hole into which the optical fiber is inserted.

10. The optical connector according to claim 1, wherein
the light emitter is a light-emitting element that converts an electric signal into an optical signal.

11. The optical connector according to claim 10, wherein
the light emitter is connected to the connector body, and
the light exiting the light emitter enters the lens with no change in a path of the light.

12. The optical connector according to claim 10, wherein
the connector body includes a light path changing section used to change a light path, and
a path of the light exiting the light emitter is changed by the light path changing section to cause the light to enter the lens.

13. The optical connector according to claim 1, wherein
the connector body is made of a light-transmissive material, and integrally includes the lens.

14. The optical connector according to claim 1, wherein
the connector body includes a plurality of the lenses.

15. The optical connector according to claim 1, further comprising the light emitter.

16. An optical cable, comprising
an optical connector that serves as a plug, the optical connector including a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.

17. An electronic apparatus, comprising
an optical connector that serves as a receptacle, the optical connector including a connector body that includes a lens and a diffusion section, the lens performing formation with respect to light that exits a light emitter, and causing light obtained by the formation to exit the lens, the diffusion section causing the light obtained by the formation performed by the lens to diffusely exit the diffusion section.
